(19) United States
(12) Patent Application Publication
(10) Pub. No.: US 2026/0111762 A1
(43) Pub. Date: Apr. 23, 2026

(54) METHOD AND SYSTEM FOR AI-ASSISTED VIEWER-GENERATED NARRATIVE CONTINUATION OF DISCONTINUED MEDIA PROPERTIES

(71) Applicant: Martin John Schmidt, Salem, OR (US)

(72) Inventor: Martin John Schmidt, Salem, OR (US)

(21) Appl. No.: 19/328,232

(22) Filed: Sep. 15, 2025

(51) Int. Cl. G06N 5/022; G06N 5/046

(52) U.S. Cl. CPC G06N 5/022; G06N 5/046

(57) ABSTRACT

Systems and methods are disclosed for generating viewer-customized narrative continuations of discontinued media properties using artificial intelligence under mandatory human creative control and integrated legal compliance validation. The system incorporates hierarchical trope compatibility scoring, cultural adaptation, audit trail logging, and copyright compliance analysis to ensure lawful, transparent, and human-authored narrative generation.

### BACKGROUND OF THE INVENTION

Discontinued media properties often retain substantial audience interest despite the absence of official narrative continuations. Existing content generation systems provide personalization or interactivity but lack integrated legal compliance mechanisms and human creative primacy.

### SUMMARY OF THE INVENTION

The present invention provides a hybrid legal-technical narrative generation system that integrates artificial intelligence with mandatory human creative checkpoints, copyright compliance validation, and authorship documentation.

### BRIEF DESCRIPTION OF THE DRAWINGS

FIG. 1 illustrates an overall system architecture.

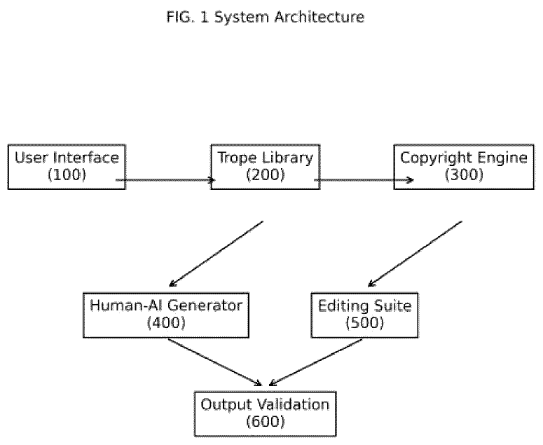

FIG. 2 illustrates a copyright compliance workflow.

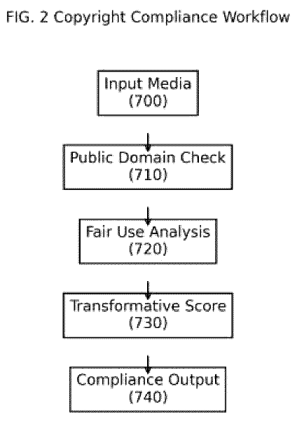

FIG. 3 illustrates a human-AI collaboration process.

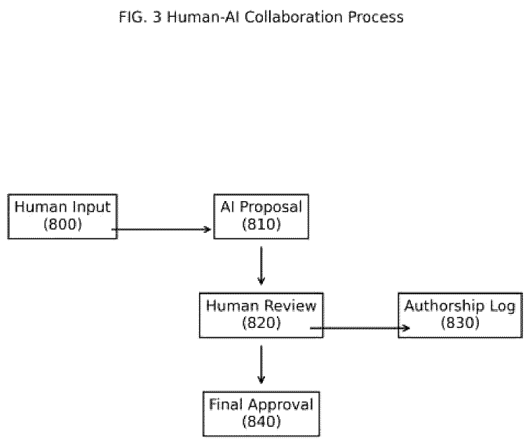

### DETAILED DESCRIPTION OF THE INVENTION

The disclosed system employs an expandable trope library organized hierarchically with compatibility scoring to guide narrative generation. Human creators approve narrative arcs, character development, and key dialogue at predefined checkpoints.

1. A computer-implemented method for generating viewer-customized narrative continuations of discontinued media properties, comprising: maintaining an expandable library of hierarchically organized narrative tropes and themes with compatibility scoring between elements and genre-specific variations; analyzing copyright status of source material including automated fair use factor evaluation, transformative nature quantification, and market impact assessment; requiring mandatory human creative input at predetermined decision points including story arc approval, character development decisions, and key dialogue creation; generating content using AI assistance while maintaining human creative primacy; and validating output for copyright compliance and fair use with compliance score generation.

2. A system for AI-assisted viewer-generated content creation comprising: a trope library management module maintaining hierarchically organized narrative elements with compatibility scoring and cultural adaptation parameters; a copyright compliance engine including fair use analysis algorithms, rights verification interfaces, and content filtering layers; a human-AI collaborative generation system requiring human approval for story arcs, character development, and dialogue creation; an advanced editing suite with AI assistance including continuity error detection, automatic match cut generation, and pacing optimization subject to human approval; an output validation module with audit trail generation; and an authorship documentation system tracking human creative contributions and maintaining chain of creative custody.

3. A non-transitory computer-readable medium storing instructions that, when executed by a processor, cause the processor to perform the method of claim 1.

4. The method of claim 1, wherein the trope library includes: hierarchically organized narrative elements with parent-child relationships; compatibility scoring algorithms that evaluate narrative coherence between elements; genre-specific variations adapted for different media types; and cultural adaptation parameters for international audience targeting.

5. The method of claim 1, wherein the copyright analysis comprises: automated evaluation of the four fair use factors under 17 U.S.C. § 107; quantitative measurement of transformative nature using predefined criteria; market impact assessment comparing original and derivative works; generation of numerical compliance scores for legal review; and audit trail documentation for rights verification.

6. The method of claim 1, wherein human creative control includes: mandatory approval checkpoints at predetermined story milestones; human-generated character development arcs and personality traits; selection and approval of actor casting or digital substitution; creation of key dialogue sequences by human writers; approval of visual style and aesthetic direction; and final editorial approval before content release.
